(19) United States
(12) Patent Application Publication
(10) Pub. No.: US 2008/0221748 A1
(43) Pub. Date: Sep. 11, 2008

(54) Control Device for a Motor Vehicle

(75) Inventors: Jurgen Kellner, Regensburg (DE); Oliver Rauh, Untermeitingen (DE)

Correspondence Address: LERNER GREENBERG STEMER LLP, P O BOX 2480, HOLLYWOOD, FL, 33022-2480, US

(73) Assignee: VDO AUTOMOTIVE AG, Regensburg (DE)

(21) Appl. No.: 12/043,461

(22) Filed: Mar. 6, 2008

(30) Foreign Application Priority Data
Mar. 6, 2007 (DE) 10 2007 010 886.0

(51) Int. Cl. G06F 7/00

(52) U.S. Cl. 701/29

(57) ABSTRACT

A control device for a motor vehicle has a microcontroller as well as a monitoring circuit for the microcontroller. The monitoring circuit has a clocked counter, with a reset input of counter being coupled to a diagnostic output of the microcontroller, a first counter output being coupled to a diagnostic trigger input of the microcontroller and a second counter output being coupled to a reset input of the microcontroller such that when the microcontroller functions correctly, a signal at the first counter output generates a diagnostic process of the microcontroller and a signal at the diagnostic output of the microcontroller resets the counter. However, when the microcontroller malfunctions, the counter is not reset, so that the counter continues to count and generates a signal for resetting the microcontroller at the second counter output.

### CROSS-REFERENCE TO RELATED APPLICATION

This application claims the priority, under 35 U.S.C. § 119, of German application DE 10 2007 010 886.0, filed Mar. 6, 2007; the prior application is herewith incorporated by reference in its entirety.

### BACKGROUND OF THE INVENTION

### Field of the Invention

The invention relates to a control device for a motor vehicle.

Particularly in motor vehicles, safety-critical functions are also being integrated more and more frequently into the control device, as controllers, which mainly contain microcontrollers, offer a plurality of application possibilities and can be adjusted to numerous operating conditions in a relatively easy fashion. However, the demands placed on the operational safety of the control devices thus increase. The control devices must thus also contain diagnostic functions, emergency operation functions and locking device functions for instance in order to be able to suitably control certain safety-relevant motor vehicle functions such as for instance hazard warning lights, windshield wipers, motor vehicle lighting or the door unlocking mechanism in the case of partial or full failure of the control device.

### SUMMARY OF THE INVENTION

It is accordingly an object of the invention to provide a control device for a motor vehicle that overcomes the above-mentioned disadvantages of the prior art devices of this general type, which contains at least some of the afore-described functions.

The object is achieved in particular by a control device containing a microcontroller, which is clocked by a first clock signal and contains at least one reset input, a diagnostic trigger input and a diagnostic output. The control device further contains a monitoring circuit for the microcontroller and the monitoring circuit has a counter clocked by a second clock signal and contains at least one reset input, a first counter output of lower weight and a second counter output of higher weight, with the reset input of the counter being coupled to the diagnostic output of the microcontroller. The first counter output is coupled to the diagnostic trigger input of the microcontroller and the second counter output is coupled to the reset input of the microcontroller such that when the microcontroller functions correctly, a signal at the first counter output triggers a diagnostic process of the microcontroller and a signal at the diagnostic output of the microphone resets the counter. However, if the microcontroller malfunctions, the counter is not reset so that this continues to count and generates a signal for resetting the microcontroller at the second counter output.

The invention is advantageous in that it achieves comprehensive monitoring and thus high operational safety with relatively little additional circuit complexity. The counter provided for the monitoring itself is also partly included in the monitoring circuit for instance.

In accordance with an added feature of the invention, the second counter output is embodied such that if the microcontroller malfunctions, the counter generates more than one signal for resetting the microcontroller.

In accordance with an additional feature of the invention, the counter has a third counter output of higher weight than the second counter output, and the third counter output outputs an emergency operation clock signal for further units in the control device, outside the control device or both.

In accordance with a further feature of the invention, the counter has a fourth counter output of higher weight than the second counter output, the fourth counter output is coupled to the reset input of the microcontroller and generates a signal for continuous reset activation.

In accordance with another feature of the invention, the monitoring circuit has a gate with an OR function, the second and fourth counter outputs are coupled to one another via the gate, the gate further coupled to the reset input of the microcontroller.

In accordance with another added feature of the invention, the signal for continuous reset activation is also provided for signaling an emergency operation.

In accordance with another further feature of the invention, the monitoring circuit has a resettable memory element, the fourth counter output is connected to the resettable memory element and through the resettable memory element is coupled to the reset input of the microcontroller. Preferably, the resettable memory element can be reset by a power-on reset signal.

In accordance with a further additional feature of the invention, the monitoring circuit has a monostable multivibrator coupled to the reset input of the microcontroller, the second counter output is connected to the monostable multivibrator and via the monostable multivibrator is coupled to the reset input of the microcontroller.

In accordance with yet another feature of the invention, the monitoring circuit has a flank generator for generating reset signals with a clear flank and is disposed upstream of the reset input of the counter.

In accordance with a concomitant feature of the invention, the first and second clock signals originate from different sources.

Other features which are considered as characteristic for the invention are set forth in the appended claims.

Although the invention is illustrated and described herein as embodied in a control device for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of safety-relevant parts of a control circuit according to the invention; and

FIG. 2 shows signal courses of different safety-relevant signals in the control circuit according to FIG. 1.

### DETAILED DESCRIPTION OF THE INVENTION

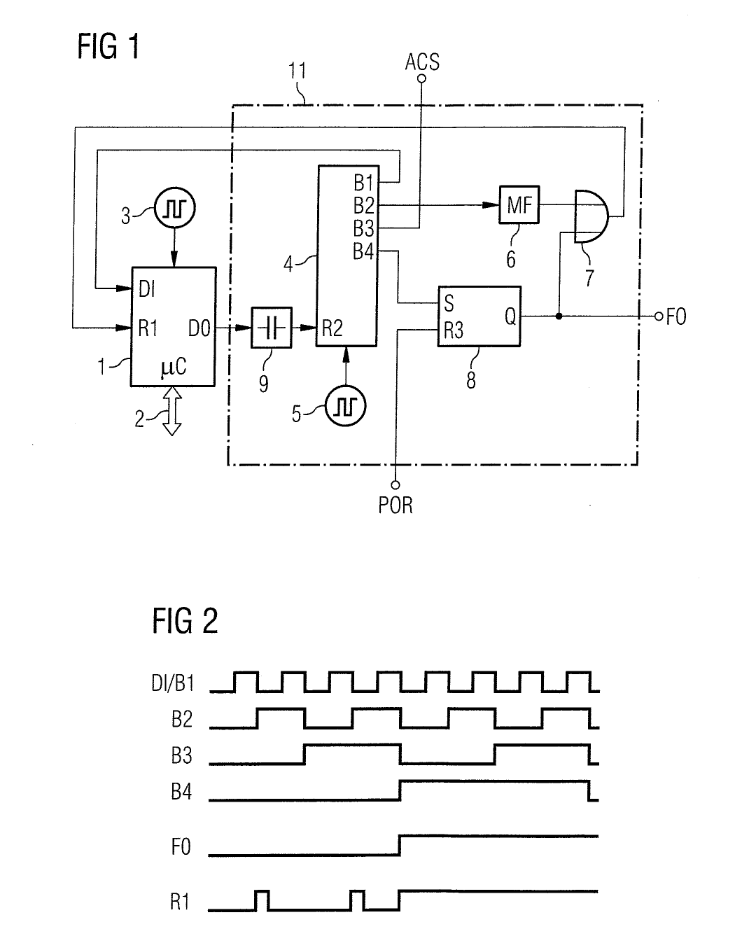

Referring now to the figures of the drawing in detail and first, particularly, to FIG. 1 thereof, there is shown an exemplary embodiment of an inventive control circuit, the control functions are generally completed by a microcontroller 1. To this end, the microcontroller 1 is connected to further circuit parts of the control circuit by way of a bus 2, the parts not however being shown in FIG. 1 for reasons of clarity. The microcontroller 1 is clocked by a first clock signal, which is provided by a clock signal source 3. Furthermore, the microcontroller 1 has at least one reset input R1, a diagnostic trigger input D1 and a diagnostic output DO.

The control circuit according to FIG. 1 also includes a monitoring circuit 11 for the microcontroller 1 having a counter 4 clocked by a second clock signal, with the second clock signal being generated by a clock signal source 5, which is independent of the clock signal source 3. An emergency operation of the monitoring circuit 11 in particular is thus ensured, if the clock signal source 3 of the microcontroller 1 fails. Furthermore, the counter 4 has at least one reset input R2 as well as counter outputs B1 to B4. In the present case, counter output B1 has the lowest weight (least significant bit) and counter output B4 the highest weight (most significant bit). Counter output B2 and counter output B3 are disposed therebetween in terms of their weight, with counter output B2 having a lower weight than counter output B3. It is however also possible for counter outputs B3 and B4 to be weighted vice versa. Furthermore, the counter can have more than four counter outputs, of which only four are then used accordingly, as a result of which different weight intervals can also be realized between the individual counter outputs.

The basic structure of the monitoring circuit 11 as well as the connection thereof to the microcontroller 1 is such that the reset input R2 of counter 4 is coupled to the diagnostic output DO of the microcontroller 1, counter output B1 is coupled to the diagnostic trigger input D1 of the microcontroller 11 and counter output B2 is coupled to the reset input R1 of the microcontroller 1. When the microcontroller 1 functions correctly, a signal at counter output B1 triggers a diagnostic process of the microcontroller 1 and a signal at the diagnostic output of the microcontroller 1 resets counter 4. If the microcontroller 1 malfunctions, counter 4 is not reset, so that this continues to count and generates a signal for resetting the microcontroller 1 at counter output B2.

With the present exemplary embodiment, counter output B2 is embodied such that if the microcontroller 1 malfunctions, it generates more than one signal in order to reset the microcontroller 1. The number in the present case is two and results here from the ratio of the weights of outputs B2 and B4, as counter output B4 delivers a signal which is divided by 4 in the frequency compared with the signal at output B2. Counter output B2 is here interconnected via a monostable memory element, namely a monoflop 6, with which it is coupled to the reset input R1 of the microcontroller in order to generate defined impulses to reset the microcontroller 1.

Counter output B3, which as already been mentioned, has a higher weight than counter output B2, provides an emergency operation clock signal ACS for further units in the control device or outside the control device or both. Autonomous circuit units for the operation of hazard warning lights, windshield wipers, the motor vehicle lighting or a door locking system can thus be operated for instance.

Counter output B4, which has a higher weight than counter output B2, is coupled to the reset input R1 of the microcontroller 1 and generates a signal for the continuous reset activation of the microcontroller 1. This means that when the microcontroller 1 no longer takes up the correct operation despite numerous resets by way of counter output B2, counter 4 continues to count and then activates the continuous reset with a specific counter state. A resettable memory element, here an RS-flip-flop 8, is disposed here downstream of counter output B4, the memory element being set by the signal at counter output B4 and being reset by a power-on reset signal POR. The linking of the signals to counter outputs B2 and B4 by interconnection via the mono-flop 6 and/or the RS-flip-flop 8 is carried out by way of a gate 7 with OR function for instance, the output of which is coupled to the reset input of the microcontroller 1. The signal for the continuous reset, in other words the signal at the output Q of the RS-flip-flop 8, is also provided for signaling an emergency operation (signal FO).

A flank generator 9 for generating reset signals with a clear flank (rising and falling edges) is finally arranged upstream of the reset input R2 of counter 4. The flank generator 9 of this type can in the simplest case be a differential element or a non post-triggerable monostable multivibrator (Monoflop).

The signal courses in FIG. 2 illustrate the procedure in the event of the microcontroller 1 malfunctioning. During correct operation, counter 4 has to be cyclically reset by the microcontroller 1, in order not to signal a malfunction. Counter 4 is reset after evaluation of the diagnostic trigger input D1 connected to counter output B1 by the microcontroller 1, with counter 4 herewith also being monitored accordingly. The diagnostic process in the microcontroller 1 can here range from a simple reaction such as for instance the immediate generation of the reset signal for counter 4 when a signal appears at the diagnostic input D1 to a complex monitoring procedure of several functions of the microcontroller 1.

If the microcontroller 1 does not or not promptly reset counter 4, counter 4 continuous to run and resets the microcontroller 1 by its counter output B2. In the present case, counter output B2 is selected here in relation to counter output B4, such that it provides two reset signals for the microcontroller 1. If the microcontroller 1 thus fails to operate correctly even with a double reset, the continuous reset and thus the emergency operation is activated by way of counter output B4. The continuous reset is used to prevent an unwanted, i.e. highly probable faulty program execution. The emergency operation clock signal ACS is however also provided by way of counter output B3, since the counter continuous to run. Safety-relevant autonomous units can herewith be powered with the emergency operation clock signal ACS and thus continue to operate. The signal triggering the continuous reset can also be provided to other units in order to signal the emergency operation function.

FIG. 2 shows that the signal at counter output B1 is a continuous clock signal which cyclically triggers a diagnostic process. If counter 4 is not reset accordingly here, a frequency division of this signal takes place on the basis of the continuous counting of counter 4, in the present case by 2. The signal divided accordingly in the frequency is present at counter output B2 and is used to reset the microcontroller 1.

A signal which is divided by four in the frequency compared with counter output B2 is present at counter output B4. Two high statuses (pulses to reset the microcontroller 1) herewith firstly appear at counter output B2, before a continuous reset is activated by the high state of the signal at counter output B4. The RS-flip-flop 8 connected downstream of counter output B4 is herewith set and continuously keeps the microcontroller reset by way of its output Q until the RS-flip-flop 8 is reset on its part by switching the power supply on and off (power-on reset).

The reset signal at the reset input R1 of the microcontroller 1 is thus produced from the OR link (or equivalent links with partial or exclusive use of inverted signals) of the output signals of the mono-flop 6 and of the RS-flip-flop 8, such that two high pulses of a duration determined by the mono-flop 6 are firstly emitted and then a high level is permanently generated. Regardless of this, a clock signal for the emergency operation is generated by counter 4 continuously counting at counter output B3, which corresponds to the signal divided by 4 in the frequency at counter output B1.

1. A control device for a vehicle, the control device comprising:
a microcontroller being clocked by a first clock signal and having at least one reset input, a diagnostic trigger input, and a diagnostic output; and
a monitoring circuit connected to and monitoring said microcontroller, said monitoring circuit having a counter clocked by a second clock signal, said counter having at least one reset input, a first counter output of a lower weight and a second counter output of a higher weight being higher than said lower weight, said reset input of said counter being coupled to said diagnostic output of said microcontroller, said first counter output being coupled to said diagnostic trigger input of said microcontroller and said second counter output being coupled to said reset input of said microcontroller such that when said microcontroller functions correctly, a signal at said first counter output triggers a diagnostic process of said microcontroller and a signal at said diagnostic output of said microcontroller resets said counter, however, when said microcontroller malfunctions, said counter is not reset and continues to count and generates a signal for resetting said microcontroller at said second counter output.

2. The control device according to claim 1, wherein said second counter output is embodied such that if said microcontroller malfunctions, said counter generates more than one signal for resetting said microcontroller.

3. The control device according to claim 1, wherein said counter has a third counter output of higher weight than said second counter output, and said third counter output outputs an emergency operation clock signal for further units in the control device, outside the control device or both.

4. The control device according to claim 3, wherein said counter has a fourth counter output of higher weight than said second counter output, said fourth counter output is coupled to said reset input of said microcontroller and generates a signal for continuous reset activation.

5. The control device according to claim 4, wherein said monitoring circuit has a gate with an OR function, said second and fourth counter outputs are coupled to one another via said gate, said gate further coupled to said reset input of said microcontroller.

6. The control device according to claim 4, wherein the signal for continuous reset activation is also provided for signaling an emergency operation.

7. The control device according to claim 4, wherein said monitoring circuit has a resettable memory element, said fourth counter output is connected to said resettable memory element and through said resettable memory element is coupled to said reset input of said microcontroller.

8. The control device according to claim 7, wherein said resettable memory element can be reset by a power-on reset signal.

9. The control device according to claim 1, wherein said monitoring circuit has a monostable multivibrator coupled to said reset input of said microcontroller, said second counter output is connected to said monostable multivibrator and via said monostable multivibrator is coupled to said reset input of said microcontroller.

10. The control device according to claim 1, wherein said monitoring circuit has a flank generator for generating reset signals with a clear flank and is disposed upstream of said reset input of said counter.

11. The control device according to claim 1, wherein the first and second clock signals originate from different sources.
